(19) United States
(12) Patent Application Publication
(10) Pub. No.: US 2022/0207739 A1
(43) Pub. Date: Jun. 30, 2022

(54) METHODS AND SYSTEMS FOR ENTERING AND VERIFYING PRODUCT SPECIFICATIONS

(71) Applicant: SUZHOU MICROPORT ORTHORECON CO., LTD., Suzhou, Jiangsu (CN)

(72) Inventors: Tianbai YU, Suzhou, Jiangsu (CN); Fubing CHEN, Suzhou, Jiangsu (CN); Min XU, Suzhou, Jiangsu (CN)

(21) Appl. No.: 17/604,701

(22) PCT Filed: Apr. 24, 2020
(86) PCT No.: PCT/CN2020/086567

§ 371 Date: Oct. 18, 2021

(30) Foreign Application Priority Data
May 20, 2019 (CN) 201910419743.5

(51) Int. Cl. G06T 7/00; G06V 10/74

(52) U.S. Cl. CPC G06T 7/0014; G06T 2207/30242; G06V 10/761

(57) ABSTRACT

Methods and systems for entering and verifying product specifications are provided. In the methods and systems for entering product specifications, a sample image and reference images under at least two conditions of a sample product for a model number to be entered are captured and processed to obtain a template image and value ranges for the sample product, which are stored as specifications for the model number and can be subsequently retrieved to verify specifications of a product. In the methods and systems for verifying product specifications, a target image of a product being verified is captured, and a template image and value ranges for a sample product associated with a model number marked on the product are retrieved. Based on the target image, template image and value ranges, it is determined whether the specifications of the concerned product match the specifications for the marked model number. This allows effective and efficient identification of the product and verification of its specifications. In addition, the verification enables checking packaging correctness of the product and thus reduces the chance of erroneous packaging.

### TECHNICAL FIELD

The present invention relates to the technical field of medical instruments and, more specifically, to methods and systems for entering and verifying product specifications.

### BACKGROUND

In the field of medical instruments, there are numerous products of a huge variety of categories each with a number of subcategories. For instance, there are over 20,000 implantable products available for spinal repair due to the complex anatomy of the human spine and the wide variation from individual to individual. Some of these products are extremely similar to one another, creating significant confusion to packaging workers and related managing personnel because even slight negligence may incur a packaging error that eventually imposes a potential threat to patients' extremity health or even their lives.

Most such packaging errors can be avoided by producing and packaging similar products in different batches separated by one or more other batches. However, due to diversified needs, this still cannot ensure sufficient difference between adjacent batches of products to avoid packaging errors arising from operators' negligence, which may create significant confusion to physicians and potentially threaten patients' lives.

Currently, products of different specifications such as length, width and opening size can be identified based on the respective fabrication tools. This can effectively avoid packaging errors to some extent. However, for applications with over 20,000 products of different specifications, this tool-based product identification approach would be impractical, let alone the fact that the tool management itself is very complex.

Therefore, there is an urgent need for solutions capable of more efficiently identifying a product with a reduced chance of erroneous packaging.

### SUMMARY OF THE INVENTION

It is an objective of the present invention to provide methods and systems for entering and verifying product specifications, with improved identification efficiency and a reduced chance of erroneous packaging, as detailed in greater particularity below.

In a first aspect of the present invention, it provides a method for entering product specifications, comprising:

capturing a sample image of a sample product for a model number to be entered, cropping a portion of the sample image where the sample product is located, and taking the cropped portion as a template image;

capturing reference images of the sample product under at least two conditions;

comparing each of the reference images with the template image to determine respective degrees of similarity thereof with the template image;

determining a value range for a degree of similarity for the sample product based on the degrees of similarity of the respective reference images with the template image;

determining values from each of the respective reference images for at least one predetermined characteristic of the sample product;

determining a value range for each of the at least one predetermined characteristic from the determined values for each of the at least one predetermined characteristic; and

storing the template image, the value range for the degree of similarity and the value range for each of the at least one predetermined characteristic to complete the entering of the specifications for the model number to be entered.

Optionally, a step for comparing each of the reference images with the template image to determine respective degrees of similarity thereof with the template image comprises:

processing the template image to derive a corresponding array thereof and processing each of the reference images to derive a corresponding array thereof; and

determining the degrees of similarity of the respective reference images with the template image by comparing the corresponding arrays of each of the reference images with the corresponding array of the template image.

Optionally, a step for processing the template image to derive the corresponding array thereof comprises

obtaining the corresponding array of the template image by binarizing the template image and converting the values of respective pixels of the binarized template image into array,

and

wherein a step for processing each of the reference images to derive the corresponding array thereof comprises

obtaining the corresponding array of each of the reference images by binarizing each of the reference images and converting the values of respective pixels of each of the binarized reference images into array.

Optionally, a step for determining the degrees of similarity of the respective reference images with the template image by comparing the corresponding arrays of each of the reference images with the corresponding array of the template image comprises:

determining the degree of similarity of each of the reference images with the template image by exhaustively comparing the corresponding array of the reference image with the corresponding array of the template image, and taking a maximum similarity value as the degree of similarity between the reference image and the template image.

Optionally, a step for determining the value range for the degree of similarity for the sample product based on the degrees of similarity of the respective reference images with the template image comprises:

calculating an average of the degrees of similarity according to the degrees of similarity of each of the reference images with the template image; and

determining the value range for the degree of similarity for the sample product based on the average.

Optionally, the at least one predetermined characteristic of the sample product includes an opening count of the sample product in the reference images, a maximum length of the sample product in the reference images and an area ratio of a region where the sample product is located to the respective reference image.

Optionally, a step for determining the values from each of the respective reference images for the at least one predetermined characteristic of the sample product comprises:

determining, from each of the reference images, value(s) for the at least one predetermined characteristic of the sample product by:
determining the opening count of the sample product from the reference image; and
establishing a coordinate system in the reference image and, in the coordinate system, measuring the maximum length of the sample product in the reference image and calculating the area ratio of a region where the sample product is located to the reference image.

In a second aspect of the present invention, it provides a system for entering product specifications, comprising:

a first image capture module for capturing a sample image of a sample product for a model number to be entered, cropping a portion of the sample image where the sample product is located, and taking the cropped portion as a template image;

a second image capture module for capturing reference images of the sample product under at least two conditions;

a first image comparison module for comparing the reference images with the template image to determine respective degrees of similarity thereof with the template image;

a first range determination module for determining a value range for a degree of similarity for the sample product based on the degrees of similarity of the respective reference images with the template image;

a first characteristic value determination module for determining values from each of the respective reference images for at least one predetermined characteristic of the sample product;

a second range determination module for determining a value range for each of the at least one predetermined characteristic from the determined values for the predetermined characteristic; and a specification entry module for storing the template image, the value range for the degree of similarity and the value range for each of the at least one predetermined characteristic to complete the entering of the specifications for the model number to be entered.

Optionally, the first image comparison module comprises:

a first array derivation unit for processing the template image to derive a corresponding array thereof and processing each of the reference images to derive a corresponding array thereof; and

a first array comparison unit for determining the degrees of similarity of the respective reference images with the template image by comparing the corresponding arrays of each of the reference images with the corresponding array of the template image.

Optionally, the first array derivation unit is further configured to:

obtain the corresponding array of the template image by binarizing the template image and converting the values of respective pixels of the binarized template image into array; and

obtain the corresponding array of each of the reference images by binarizing each of the reference images and converting the values of respective pixels of each of the binarized reference images into array.

Optionally, the first array comparison unit is further configured to:

determine the degree of similarity of each of the reference images with the template image by exhaustively comparing the corresponding array of each of the reference image with the corresponding array of the template image, and take a maximum similarity value as the degree of similarity between the reference image and the template image.

Optionally, the first range determination module is further configured to:

calculate an average of the degrees of similarity of the reference images with the template image; and

determine the value range for the degree of similarity for the sample product based on the average.

Optionally, the at least one predetermined characteristic of the sample product includes an opening count of the sample product in the reference images, a maximum length of the sample product in the reference images and an area ratio of a region where the sample product is located to the respective reference image.

Optionally, the first characteristic value determination module is further configured to:

determine, from each of the reference images, value(s) for the at least one predetermined characteristic of the sample product by:
determining the opening count of the sample product from the reference image; and
establishing a coordinate system in the reference image and, in the coordinate system, measuring the maximum length of the sample product in the reference image and calculating the area ratio of a region where the sample product is located to the reference image.

In a third aspect of the present invention, it provides a method for verifying product specifications, comprising:

capturing a target image of a product to be verified;

retrieving a template image and value ranges for a sample product having the same model number with the product to be verified, the value ranges including a value range for a degree of similarity and value range(s) for at least one predetermined characteristic;

comparing the target image with the template image to determine a degree of similarity therebetween;

if the degree of similarity is within the value range for the degree of similarity, then determining, from the target image, value(s) of the at least one predetermined characteristic of the product to be verified; and

determining whether specifications of the product to be verified match those for the model number with which the product to be verified is identified through determining whether the value(s) of the at least one predetermined characteristic is/are within the respective value range(s) for at least one predetermined characteristic.

Optionally, a step for comparing the target image with the template image to determine the degree of similarity therebetween comprises:

processing the target image to derive a corresponding array thereof and processing the template image to derive a corresponding array thereof; and

determining the degree of similarity of the target image with the template image by comparing the corresponding array of the target image with the corresponding array of the template image.

Optionally, a step for processing the target image to derive the corresponding array thereof comprises

obtaining the corresponding array of the target image by binarizing the target image and converting the values of respective pixels of the binarized target image into array,

and

wherein a step for processing the template image to derive the corresponding array thereof comprises

obtaining the corresponding array of the template image by binarizing the template image and converting the values of respective pixels of each of the binarized template images into array.

Optionally, a step for determining the degree of similarity of the target image with the template image by comparing their corresponding arrays comprises:

determining the degree of similarity of the target image with the template image by exhaustively comparing the corresponding array of the target image with the corresponding array of the template image, and taking a maximum similarity value as the degree of similarity between the target image and the template image.

Optionally, the at least one predetermined characteristic of the product to be verified includes an opening count of the product in the target image, a maximum length of the product in the target image and an area ratio of a region where the product is located to the target image.

Optionally, a step for determining, from the target image, the value(s) of the at least one predetermined characteristic of the product to be verified comprises:

determining the opening count of the product from the target image; and

establishing a coordinate system in the target image and, in the coordinate system, measuring the maximum length of the product to be verified in the target image and calculating the area ratio of a region where the product to be verified is located to the target image.

Optionally, the method further comprises:

storing the target image of the product to be verified, the degree of similarity of the target image with the template image and the value(s) of the at least one predetermined characteristic of the product to be verified.

In a fourth aspect of the present invention, it provides a system for verifying product specifications, comprising:

a third image capture module for capturing a target image of a product to be verified;

a sample product information retrieval module for retrieving a template image and value ranges for a sample product having the same model number with the product to be verified, the value ranges including a value range for a degree of similarity and value range(s) for at least one predetermined characteristic;

a second image comparison module for comparing the target image with the template image to determine a degree of similarity therebetween;

a second characteristic value determination module for, if the degree of similarity is within the value range for the degree of similarity, determining, from the target image, value(s) of the at least one predetermined characteristic of the product to be verified; and

a specification verification module for determining whether specifications of the product match those for the model number with which the product to be verified is identified through determining whether the value(s) of the at least one predetermined characteristic is/are within the respective value range(s) for at least one predetermined characteristic.

Optionally, the second image comparison module comprises:

a second array derivation unit for processing the target image to derive a corresponding array thereof and processing the template image to derive a corresponding array thereof; and

a second array comparison unit for determining the degree of similarity of the target image with the template image by comparing the corresponding array of the target image with the corresponding array of the template image.

Optionally, the second array derivation unit is further configured to:

obtain the corresponding array of the target image by binarizing the target image and converting the values of respective pixels of the binarized target image into array; and

obtain the corresponding array of the template image by binarizing the template image and converting the values of respective pixels of each of the binarized template images into array.

Optionally, the second array comparison unit is further configured to:

determine the degree of similarity of the target image with the template image by exhaustively comparing the corresponding array of the target image with the corresponding array of the template image, and take a maximum similarity value as the degree of similarity between the target image and the template image.

Optionally, the at least one predetermined characteristic of the product to be verified includes an opening count of the product in the target image, a maximum length of the product to be verified in the target image and an area ratio of a region where the product is located to the target image.

Optionally, the second characteristic value determination module is further configured to:

determine the opening count of the product from the target image; and

establish a coordinate system in the target image and, in the coordinate system, measure the maximum length of the product to be verified and calculate the area ratio of a region where the product is located to the target image.

Optionally, the system further comprises:

an information storage module for storing the target image of the product to be verified, the degree of similarity of the target image with the template image and the value(s) of the at least one predetermined characteristic of the product.

Compared with the prior art, the methods and systems provided in the present invention have the following advantages:

A sample image and reference images under at least two conditions of a sample product for a model number to be entered are captured and processed to obtain a template image and value ranges for the sample product, which are stored as specifications for the model number and can be subsequently retrieved to verify specifications of a product. This enables automatic entry of product specifications at an increased speed.

A target image of a product being verified is captured, and a template image and value ranges for a sample product associated with a model number with which the product is identified are retrieved. Based on the target image, template image and value ranges, it is determined whether the specifications of the concerned product match the specifications for the model number with which the product is identified. This allows effective and efficient identification of the product and verification of its specifications. In addition, the verification enables checking packaging correctness of the product and thus reduces the chance of erroneous packaging.

### BRIEF DESCRIPTION OF THE DRAWINGS

FIG. 1 is a flowchart of a method for entering product specifications according to an embodiment of the present invention;

FIG. 2 is a flowchart of a method for verifying product specifications according to an embodiment of the present invention;

FIG. 3 is a schematic view of the structure of an apparatus for entering product specifications according to an embodiment of the present invention; and

FIG. 4 is a schematic view of the structure of an apparatus for verifying specifications of a product according to an embodiment of the present invention.

### DETAILED DESCRIPTION

The core idea of the present invention is to achieve product identification by means of entry and verification of product specifications. During the entry, for each model number, a sample product is chosen, and a template image and value ranges of parameters (including degree of similarity and at least one predetermined characteristic) of the sample product are acquired and stored as specifications for the model number. In order to verify specifications of a product, a model number with which the product is identified is obtained and a template image and value ranges of parameters of an associated sample product are retrieved. If an image of the product being verified has a degree of similarity with the template image that is within a retrieved value range for the degree of similarity, and a value of each of at least one predetermined characteristic thereof is within a retrieved value range for the specific predetermined characteristic, it is determined that the specifications of the product being verified are the same as those of the sample, i.e., the model number with which the product is identified is correct. This allows a product to be more effectively and efficiently identified, leaving a reduced chance of erroneous packaging.

Objectives, advantages and features of the present invention will be readily apparent upon a reading of the following detailed description of particular embodiments when taken in conjunction with the accompanying drawings.

A method for entering product specifications proposed in the present invention is described below.

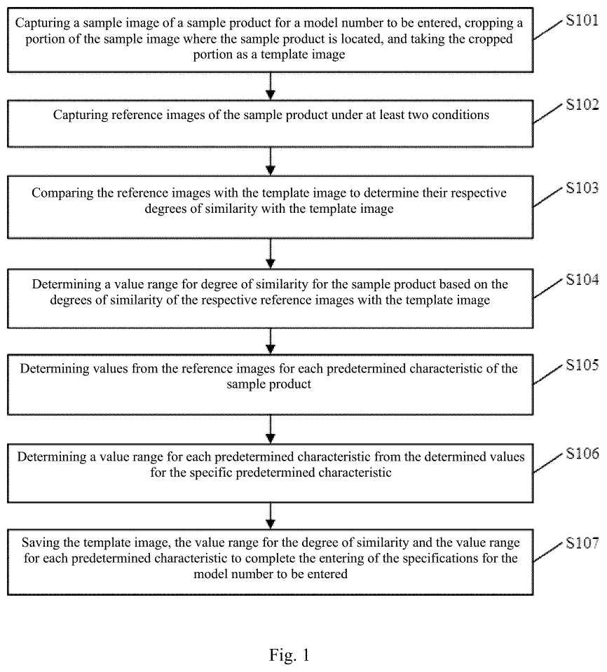

Reference is now made to FIG. 1, a flowchart of the method according to an embodiment of the present invention. As shown, the method includes the following steps.

Step S101: Capturing a sample image of a sample product for a model number to be entered, cropping a portion of the sample image where the sample product is located, and taking the cropped portion as a template image.

The model number, also referred to as a product ID, is a code consisting of numbers and/or letters, which is assigned by the manufacturer to identify a type of product from other types. In this embodiment, the sample image may be captured by an image capture device, which may be either an imaging system specially designed for this purpose or a common camera for home use, depending on whether the product is complex in morphology and whether it is easily distinguishable. However, in certain embodiments, the imaging system may be made up of a high-speed camera for industrial use, a prime lens, an annular array light source, a camera power supply, a light source controller and high-speed shielded patch cables.

The template image, i.e., the cropped portion of the captured sample image where the sample product is located, may be subsequently used to verify whether a product is of the same model type. For example, the cropping may be accomplished by slicing the sample image to obtain the portion where the sample product is located as the template image.

Step S102: Capturing reference images of the sample product under at least two conditions.

In particular, the sample product may be placed at different locations, and the reference images may be captured at the respective locations. The reference images captured at the locations may serve as a basis for deriving a value range for each of at least one predetermined characteristic of the sample product. The number of captured reference images may be determined as actually required and may be five (5), for example. It would be appreciated that the condition under which the sample image is captured in step S101 may be taken as one of the at least two conditions. Therefore, it is possible to capture image(s) under only at least one other condition in step S102.

Step S103: Comparing the reference images with the template image to determine their respective degrees of similarity with the template image.

Specifically, in one embodiment, the template image may be processed to derive a corresponding array. Each of the reference images may also be processed to derive a corresponding array, which may be then compared to the corresponding array of the template image to determine a degree of similarity of the specific reference image with the template image.

The processing of the template image may involve binarizing the template image and converting the values of respective pixels of the binarized template image into array. Each of the values may be either 0 or 255 in the grayscale. In this way, the corresponding array of the template image consists of the same number of elements each assuming a value of 0 or 255 as the number of pixels of the image.

Similarly, processing of each reference image may involve binarizing the specific reference image and converting the values of respective pixels of each of the binarized reference images into array.

The degree of similarity of each reference image with the template image may be determined by exhaustively comparing their corresponding arrays and taking a maximum similarity value as the degree of similarity between the two images.

It would be appreciated that, in this embodiment, the exhaustive comparison between the two arrays involves comparing the corresponding array of the template image with a corresponding sub-array of the corresponding array of the specific reference image of every region of the reference image (with the same size as the template image) to determine the number of matched elements between the two arrays as a similarity value for the region with respect to the template image. The similarity value of each region of the reference image represents how the region is similar to the template image, and the region of the reference image that is most similar to the template image is generally a region where the sample product is located. Therefore, the region with the greatest similarity value is generally the region where the sample product is located, and the similarity value thereof (i.e., the maximum similarity value) is taken as the degree of similarity of the reference image with the template image.

Step S104: Determining a value range for degree of similarity for the sample product based on the degrees of similarity of the respective reference images with the template image.

Specifically, an average of the degrees of similarity of the reference images with the template image may be calculated, and the value range for the degree of similarity for the sample product may be determined based on the average.

For example, five reference images may be captured, and their average degree of similarity with the template image may be calculated. The value range for the degree of similarity may be then determined by setting an appropriate lower limit based on the average.

Step S105: Determining values from the reference images for each predetermined characteristic of the sample product.

The characteristic(s) of the sample product may be determined according to its shape and structure. In one embodiment, three characteristics of the sample product may be determined: an opening count of the sample product in the reference images, a maximum length of the sample product in the reference images and an area ratio of a region where the sample product is located to the respective reference image.

Specifically, from each reference image, values for the three predetermined characteristics may be determined by:

determining the opening count of the sample product from the specific reference image; and

establishing a coordinate system in the reference image and, in the coordinate system, measuring the maximum length of the sample product and calculating the area ratio of a region where the sample product is located to the reference image.

In this embodiment, the opening count of the sample product may be determined by counting the number of encircled regions in the corresponding array of the reference image. For example, for any region in the reference image, if all the elements of the corresponding array within the region are valued at 255, while surrounding elements are all valued at 0, then it can be determined that the region corresponds to an opening. In this way, the opening count of the sample product can be determined by counting all such regions in the reference image. Alternatively, the opening count may also be determined by counting the number of openings manually or using an image recognition technique.

The coordinate system established in the reference image may have an X axis extending in a lengthwise direction of the sample product and a Y axis perpendicular to the lengthwise direction. A dimension of the sample product along the direction of the X axis may be measured as the maximum length thereof. Further, the area ratio may be calculated by dividing an area confined by an outline of the sample product by the total area of the reference image.

Step S106: Determining a value range for each predetermined characteristic from the determined values for the specific predetermined characteristic.

Specifically, for each predetermined characteristic, an average of the determined values for the specific predetermined characteristic may be calculated, and the value range for the predetermined characteristic may be then determined based on the average.

For example, maximum length values determined from the respective reference images may be averaged, and a value range for the maximum length may be then determined by setting appropriate upper and lower limits based on the average. However, since the sample product has a constant number of openings (e.g., 3 openings), the value range for opening count is determined as a constant value, e.g., 3.

Step S107: Saving the template image, the value range for the degree of similarity and the value range for each predetermined characteristic to complete the entering of the specifications for the model number to be entered.

As the specifications of the product with the model number, the template image and the value ranges (including the value range for the degree of similarity and the value range for each predetermined characteristic) may be entered and stored in association with the model number of the product.

In one embodiment, data of the value ranges may be entered in a file saved in a folder where the template image is saved, the folder being named with the model number of the product. Organizing template images and data of the value ranges of a large number of products in such an orderly manner enables the establishment of a large product information repository from which specifications of a certain product can be easily retrieved at a later time.

In summary, in the above method, a sample image and reference images under at least two conditions of a sample product for a model number to be entered are captured and processed to obtain a template image and value ranges for the sample product, which are stored as specifications for the model number and can be subsequently retrieved to verify specifications of a product. This enables automatic entry of product specifications at an increased speed.

A method for verifying specifications of a product proposed in the present invention is described below.

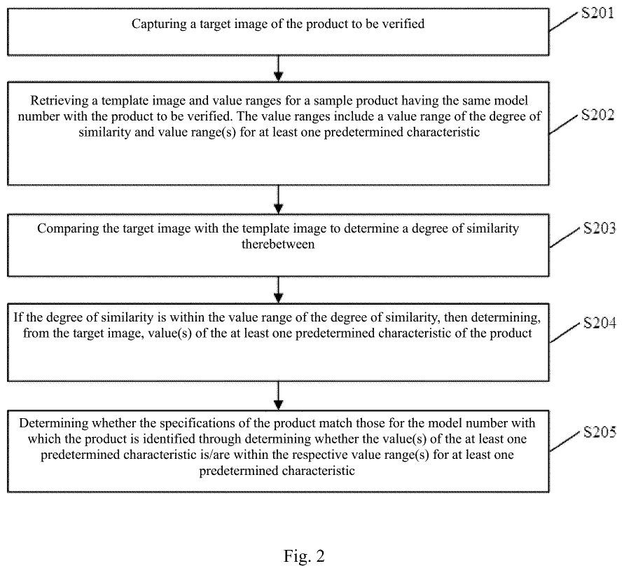

Reference is now made to FIG. 2, a flowchart of the method according to an embodiment of the present invention. As shown, the method includes the following steps.

Step S201: Capturing a target image of the product to be verified.

It is to be noted that this embodiment aims to verify whether specifications of the concerned product match those for a model number with which the product is identified as entered as described in the previous embodiment. Since the verification is based on the target image captured in this step, in order to prevent any error from occurring during the image capture action, the same image capture device used in the previous embodiment to capture the sample image is used in this embodiment to capture the target image.

Step S202: Retrieving a template image and value ranges for a sample product having the same model number with the product to be verified. The value ranges include a value range of the degree of similarity and value range(s) for at least one predetermined characteristic.

Specifically, the template image and value ranges for the sample product having the same model number with the product to be verified may be retrieved based on a representation of the model number. The model number may be marked on the product in the form of a barcode and may be obtained by scanning the barcode. Alternatively, it may be obtained simply by manual entry.

Step S203: Comparing the target image with the template image to determine a degree of similarity therebetween.

Specifically, in one embodiment, the target image may be processed to derive a corresponding array thereof. Likewise, the template image may also be processed to derive a corresponding array thereof, which may be then compared to the corresponding array of the target image to determine the degree of similarity of the target image with the template image.

The processing of the target image may involve binarizing the target image and converting the values of respective pixels of the binarized target image into array. Each of the values may be either 0 or 255 in the grayscale. In this way, the corresponding array of the target image consists of the same number of elements each assuming a value of 0 or 255 as the number of pixels of the image.

Likewise, the processing of the template image may involve binarizing the template image and converting the values of respective pixels of the binarized template image into array. Each of the values may be either 0 or 255 in the grayscale. In this way, the corresponding array of the template image consists of the same number of elements each assuming a value of 0 or 255 as the number of pixels of the image.

The degree of similarity of the target image with the template image may be determined by exhaustively comparing their corresponding arrays and taking a maximum similarity value as the degree of similarity between the two images.

A determination may be then made of whether the degree of similarity of the target image with the template image is within the value range for the degree of similarity. If not, it means that the target image is insufficiently similar to the template image. That is, the product being verified is not similar to the sample product, and it may be directly determined that the specifications of the product mismatch with those for the model number with which the product is identified. Otherwise, it means that the target image is rather similar to the template image. That is, the product being verified is sufficiently similar to the sample product, but further comparison(s) in terms of the at least one predetermined characteristic between them is/are further necessary to determine whether or not the specifications of the product match with those for the model number with which the product is identified.

Step S204: If the degree of similarity is within the value range of the degree of similarity, then determining, from the target image, value(s) of the at least one predetermined characteristic of the product.

The at least one predetermined characteristic of the concerned product is same as the at least one predetermined characteristic of the sample product. For example, there are three characteristics for the concerned products: an opening count of the sample product in the target image, a maximum length of the sample product in the target image and an area ratio of a region where the sample product is located to the target image. It is to be noted that, depending on the properties of the product, the predetermined characteristic(s) may alternatively or additionally include the product's maximum width or other geometric characteristics such as radius (when the product is circular). Moreover, depending on the complexity of the product and its similarity to one or more other products, one, two, three, four or more predetermined characteristics may be used, without limiting the scope of the present invention.

Specifically, for the above case with three predetermined characteristics being used, values for these predetermined characteristics of the product may be determined from the target image by:

determining the opening count of the product from the target image; and

establishing a coordinate system in the target image and, in the coordinate system, measuring the maximum length of the product and calculating the area ratio of a region where the product is located to the target image.

In this embodiment, the opening count of the concerned product may be determined by counting the number of encircled regions in the corresponding array of the target image. For example, for any region in the target image, if all the elements of the corresponding array within the region are valued at 255, while surrounding elements are all valued at 0, then it can be determined that the region corresponds to an opening. In this way, the opening count of the product can be determined by counting all such regions in the target image. Alternatively, the opening count may also be determined by counting the number of openings manually or using an image recognition technique.

The coordinate system established in the target image may have an X axis extending in a lengthwise direction of the concerned product and a Y axis perpendicular to the lengthwise direction. A dimension of the product along the direction of the X axis may be measured as the maximum length thereof. Further, the area ratio may be calculated by dividing an area confined by an outline of the product by the total area of the target image.

Step S205: Determining whether the specifications of the product match those for the model number with which the product is identified through determining whether the value(s) of the at least one predetermined characteristic is/are within the respective value range(s) for at least one predetermined characteristic.

For each predetermined characteristic, the value thereof may be compared with the respective value range. If all the value(s) is/are within the respective range(s), then it is determined that the specifications of the concerned product match those for the model number with which the product is identified. That is, the model number with which the product is identified is actually the correct model number of the product. If the value of any predetermined characteristic is not within the respective range, then it is determined that the specifications of the concerned product do not match those for the model number with which the product is identified. In this case, it may be further verified whether the product is correctly packaged or not. In the latter case, further processing may be necessary to rectify the package error.

For instance, there are numerous products available for spinal repair, which assume various shapes. While most of them can be identified and distinguished simply by checking their template images, there are still some that are substantially similar in shape and only differ in terms of size or number of openings. These products can be verified as to whether they are identified with the correct model numbers by additionally evaluating one or more predetermined characteristics such as opening count, length and/or area ratio.

Subsequent to the verification whose result is that the specifications of the product match those for the model number with which the product is identified, the target image and its degree of similarity with the template image and value(s) of the predetermined characteristic(s) may be stored. In one embodiment, such information may be stored in associated with an identified serial number of the product (which is a unique identifier of the product). In other embodiments, such information may also be stored in associated with other information of the product including its model number, batch number (an identifier of the batch in which the product, as well as other products of the same model type, is produced) and operator (the person who performs the verification) information. This enables traceability and query of the information.

In summary, in the above method, a target image of a product being verified is captured, and a template image and value ranges for a sample product associated with a model number with which the product is identified are retrieved. Based on the target image, template image and value ranges, it is determined whether the specifications of the concerned product match the specifications for the model number with which the product is identified. This allows effective and efficient identification of the product and verification of its specifications. In addition, the verification enables checking packaging correctness of the product and thus reduces the chance of erroneous packaging.

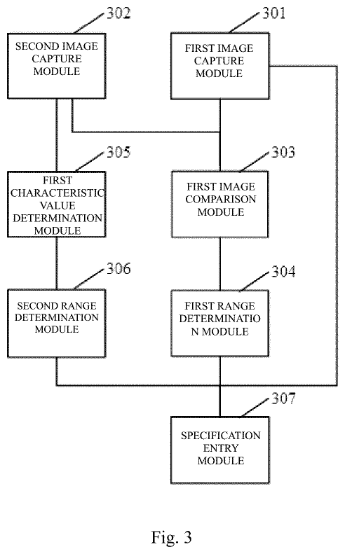

In the present invention, there is also provided a system for entering product specifications corresponding to the above method for entering product specifications. FIG. 3 is a structural schematic of the system according to an embodiment of the present invention. As shown, the system includes:

a first image capture module 301 for capturing a sample image of a sample product for a model number to be entered, cropping a portion of the sample image where the sample product is located, and taking the cropped portion as a template image;

a second image capture module 302 for capturing reference images of the sample product under at least two conditions;

a first image comparison module 303 for comparing the reference images with the template image to determine their respective degrees of similarity with the template image;

a first range determination module 304 for determining a value range for degree of similarity for the sample product based on the degrees of similarity of the respective reference images with the template image;

a first characteristic value determination module 305 for determining values from the respective reference images for each of at least one predetermined characteristic of the sample;

a second range determination module 306 for determining a value range for each predetermined characteristic from the determined values for the specific predetermined characteristic; and

a specification entry module 307 for storing the template image, the value range for the degree of similarity and the value range for each predetermined characteristic to complete the entering of the specifications for the model number to be entered.

Optionally, the first image comparison module 303 may include:

a first array derivation unit for processing the template image to derive a corresponding array thereof and processing each reference image to derive a corresponding array thereof; and

a first array comparison unit for determining the degrees of similarity of the respective reference images with the template image by comparing the corresponding arrays of the reference images with the corresponding array of the template image.

Optionally, the first array derivation unit may be in particular configured to:

obtain the corresponding array of the template image by binarizing the template image and converting the values of respective pixels of the binarized template image into array; and

obtain the corresponding array of each reference image by binarizing each of the reference images and converting the values of respective pixels of each of the binarized reference images into array.

Optionally, the first array comparison unit may be in particular configured to:

determine the degree of similarity of each reference image with the template image by exhaustively comparing their corresponding arrays, and take a maximum similarity value as the degree of similarity between the two images.

Optionally, the first range determination module 304 may be in particular configured to:

calculate an average of the degrees of similarity of the reference images with the template image; and

determine the value range for the degree of similarity for the sample product based on the average.

Optionally, the at least one predetermined characteristic of the sample product may include an opening count of the sample product in the reference images, maximum length of the sample product in the reference images and area ratio of a region where the sample product is located to the respective reference image.

Optionally, the first characteristic value determination module 305 may be in particular configured to:

determine, from each of the reference images, value(s) for the at least one predetermined characteristic through:

determining the opening count of the sample product from the specific reference image; and

establishing a coordinate system in the reference image and, in the coordinate system, measuring the maximum length of the sample product and calculating the area ratio of a region where the sample product is located to the reference image.

With the above system, a sample image and reference images under at least two conditions of a sample product for a model number to be entered are captured and processed to obtain a template image and value ranges for the sample product, which are stored as specifications for the model number and can be subsequently retrieved to verify specifications of a product. This enables automatic entry of product specifications at an increased speed.

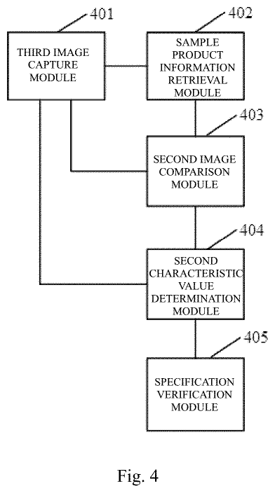

In the present invention, there is also provided a system for verifying product specifications corresponding to the above method for verifying product specifications. FIG. 4 is a structural schematic of the system according to an embodiment of the present invention. As shown, the system includes:

a third image capture module 401 for capturing a target image of the product;

a sample product information retrieval module 402 for retrieving a template image and value ranges for a sample product having the same model number with the product to be verified, the value ranges including a value range of the degree of similarity and value range(s) for at least one predetermined characteristic;

a second image comparison module 403 for comparing the target image with the template image to determine a degree of similarity therebetween;

a second characteristic value determination module 404 for, if the degree of similarity is within the value range of the degree of the similarity, then determining, from the target image, value(s) of the at least one predetermined characteristic of the produce; and

a specification verification module 405 for determining whether the specifications of the product match those for the model number with which the product is identified through determining whether the value(s) of the at least one predetermined characteristic is/are within the respective value range(s) for at least one predetermined characteristic.

Optionally, the second image comparison module 403 may include:

a second array derivation unit for processing the target image to derive a corresponding array thereof and processing the template image to derive a corresponding array thereof; and

a second array comparison unit for determining the degree of similarity of the target image with the template image by comparing their corresponding arrays.

Optionally, the second array derivation unit may be in particular configured to:

obtain the corresponding array of the target image by binarizing the target image and converting the values of respective pixels of the binarized target image into array; and

obtain the corresponding array of the template image by binarizing the template image and converting the values of respective pixels of the binarized template image into array.

Optionally, the second array comparison unit may be in particular configured to:

determine the degree of similarity of the target image with the template image by exhaustively comparing their corresponding arrays, and take a maximum similarity value as the degree of similarity between the two images.

Optionally, the at least one predetermined characteristic of the product may include an opening count of the product in the target image, a maximum length of the product in the target image and an area ratio of a region where the product is located to the target image.

Optionally, the second characteristic value determination module 404 may be in particular configured to:

determine the opening count of the product from the target image; and

establish a coordinate system in the target image and, in the coordinate system, measure the maximum length of the product and calculate the area ratio of a region where the product is located to the target image.

Optionally, the system may further include:

an information storage module for storing the target image of the product, the degree of similarity of the target image with the template image and the value(s) of the at least one predetermined characteristic of the product.

With the system, a target image of a product being verified is captured, and a template image and value ranges for a sample product associated with a model number with which the product is identified are retrieved. Based on the target image, template image and value ranges, it is determined whether the specifications of the concerned product match the specifications for the model number with which the product is identified. This allows effective and efficient identification of the product and verification of its specifications. In addition, the verification enables checking packaging correctness of the product and thus reduces the chance of erroneous packaging.

It is to be noted that the embodiments disclosed herein are described in an inter-related manner with the description of each embodiment focusing on its differences from others, and reference can be made between the embodiments for their identical or similar parts. In particular, since the system embodiments are substantially similar to the method embodiments they are described relatively briefly, and reference can be made to the method embodiments for details in them.

As used herein, relational terms such as first and second, etc., are only used to distinguish one entity or operation from another entity or operation, and do not necessarily require or imply these entities having such an order or sequence. Moreover, the terms “include”, “including”, or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment. In the case of no more limitation, the element defined by the sentence “includes a . . . ” does not exclude the existence of another identical element in the process, the method, or the device including the element.

The description presented above is merely that of a few preferred embodiments of the present invention and is not intended to limit the scope thereof in any sense. Any and all changes and modifications made by those of ordinary skill in the art based on the above teachings fall within the scope as defined in the appended claims.

1-7. (canceled)

8. A system for entering product specifications, comprising:
a first image capture module for capturing a sample image of a sample product for a model number to be entered, cropping a portion of the sample image where the sample product is located, and taking the cropped portion as a template image;
a second image capture module for capturing reference images of the sample product under at least two conditions;
a first image comparison module for comparing the reference images with the template image to determine respective degrees of similarity thereof with the template image;
a first range determination module for determining a value range for a degree of similarity for the sample product based on the degrees of similarity of the respective reference images with the template image;
a first characteristic value determination module for determining values from each of the respective reference images for at least one predetermined characteristic of the sample product;
a second range determination module for determining a value range for each of the at least one predetermined characteristic from the determined values for the predetermined characteristic; and
a specification entry module for storing the template image, the value range for the degree of similarity and the value range for each of the at least one predetermined characteristic to complete the entering of the specifications for the model number to be entered.

9. The system for entering product specifications according to claim 8, wherein the first image comparison module comprises:
a first array derivation unit for processing the template image to derive a corresponding array thereof and processing each of the reference images to derive a corresponding array thereof; and
a first array comparison unit for determining the degrees of similarity of the respective reference images with the template image by comparing the corresponding arrays of each of the reference images with the corresponding array of the template image.

10. The system for entering product specifications according to claim 9, wherein the first array derivation unit is further configured to:
obtain the corresponding array of the template image by binarizing the template image and converting the values of respective pixels of the binarized template image into array; and
obtain the corresponding array of each of the reference images by binarizing each of the reference images and converting the values of respective pixels of each of the binarized reference images into array.

11. The system for entering product specifications according to claim 9, wherein the first array comparison unit is further configured to:
determine the degree of similarity of each of the reference images with the template image by exhaustively comparing the corresponding array of each of the reference image with the corresponding array of the template image, and take a maximum similarity value as the degree of similarity between the reference image and the template image.

12. The system for entering product specifications according to claim 8, wherein the first range determination module is further configured to:
calculate an average of the degrees of similarity of the reference images with the template image; and
determine the value range for the degree of similarity for the sample product based on the average.

13. The system for entering product specifications according to claim 8, wherein the at least one predetermined characteristic of the sample product includes an opening count of the sample product in the reference images, a maximum length of the sample product in the reference images and an area ratio of a region where the sample product is located to the respective reference image.

14. The system for entering product specifications according to claim 13, wherein the first characteristic value determination module is further configured to:
determine, from each of the reference images, value(s) for the at least one predetermined characteristic of the sample product by:
determining the opening count of the sample product from the reference image; and
establishing a coordinate system in the reference image and, in the coordinate system, measuring the maximum length of the sample product in the reference image and calculating the area ratio of a region where the sample product is located to the reference image.

15-21. (canceled)

22. A system for verifying product specifications, comprising:
a third image capture module for capturing a target image of a product to be verified;
a sample product information retrieval module for retrieving a template image and value ranges for a sample product having the same model number with the product to be verified, the value ranges including a value range for a degree of similarity and value range(s) for at least one predetermined characteristic;
a second image comparison module for comparing the target image with the template image to determine a degree of similarity therebetween;
a second characteristic value determination module for, if the degree of similarity is within the value range for the degree of similarity, determining, from the target image, value(s) of the at least one predetermined characteristic of the product to be verified; and
a specification verification module for determining whether specifications of the product match those for the model number with which the product to be verified is identified through determining whether the value(s) of the at least one predetermined characteristic is/are within the respective value range(s) for at least one predetermined characteristic.

23. The system for verifying product specifications according to claim 22, wherein the second image comparison module comprises:
a second array derivation unit for processing the target image to derive a corresponding array thereof and processing the template image to derive a corresponding array thereof; and
a second array comparison unit for determining the degree of similarity of the target image with the template image by comparing the corresponding array of the target image with the corresponding array of the template image.

24. The system for verifying product specifications according to claim 23, wherein the second array derivation unit is further configured to:
obtain the corresponding array of the target image by binarizing the target image and converting the values of respective pixels of the binarized target image into array; and
obtain the corresponding array of the template image by binarizing the template image and converting the values of respective pixels of each of the binarized template images into array.

25. The system for verifying product specifications according to claim 23, wherein the second array comparison unit is further configured to:
determine the degree of similarity of the target image with the template image by exhaustively comparing the corresponding array of the target image with the corresponding array of the template image, and take a maximum similarity value as the degree of similarity between the target image and the template image.

26. The system for verifying product specifications according to claim 22, wherein the at least one predetermined characteristic of the product to be verified includes an opening count of the product in the target image, a maximum length of the product to be verified in the target image and an area ratio of a region where the product is located to the target image.

27. The system for verifying product specifications according to claim 26, wherein the second characteristic value determination module is further configured to:
determine the opening count of the product from the target image; and
establish a coordinate system in the target image and, in the coordinate system, measure the maximum length of the product to be verified and calculate the area ratio of a region where the product is located to the target image.

28. The system for verifying product specifications according to claim 22, further comprising:
an information storage module for storing the target image of the product to be verified, the degree of similarity of the target image with the template image and the value(s) of the at least one predetermined characteristic of the product.
